(19) United States
(12) Patent Application Publication
(10) Pub. No.: US 2013/0191315 A1
(43) Pub. Date: Jul. 25, 2013

(54) METHOD OF DYNAMIC MODELING OF THE WORKFLOW, WITH THE USE OF INFORMATION SYSTEM

(71) Applicant: Przemyslaw Soldacki, Warsaw (PL)

(72) Inventor: Przemyslaw Soldacki, Warsaw (PL)

(21) Appl. No.: 13/824,442

(22) PCT Filed: Aug. 31, 2011
(86) PCT No.: PCT/PL11/00093

§ 371 Date: Mar. 18, 2013

(30) Foreign Application Priority Data
Sep. 29, 2010 (PL) P-392534

(51) Int. Cl. G06N 5/02

(52) U.S. Cl. CPC G06N 5/02
USPC 706/46

(57) ABSTRACT

The method of dynamic modeling of workflow, with the use of information system is characterized in that, the analysis of workflow processes, the effect of which is procedures, is performed automatically by information system, in such a way, that on the basis of information, as obtained from the systems users during daily work, all actions taken by the users are registered, including the history of changes in each case, and then registered in this way flow of information between the persons and stages in every procedure is subjected to the automatic analysis, as a result of which the procedure diagrams are created with definable level of detail, that in the case of users behavior change are updated instantly, and in addition for prediction of user's behavior on the basis of taken by them decisions during the handing over cases, and the changes of the case stages, as well as all available information, classifiers and vector representations of the text content are automatically created, which are then used to suggest decisions concerning the next stage of procedure, as well as the next user, which should receive the case on the basis of information about current user, present stage, previous stages, previous user, text contents as well as the metadata (additional attributes of given case) and also on the basis of the text content of new case, recognized and suggested is a procedure, according to which the given case should be carried on.

### CROSS REFERENCE TO RELATED APPLICATIONS

This application is the U.S. national stage of International Application No. PCT/PL2011/000093, filed on Aug. 31, 2011, and claims the benefit thereof. The international application claims the benefits of Polish Application No. P-392534 filed on Sep. 29, 2010; all applications are incorporated by reference herein in their entirety.

### BACKGROUND

The invention relates to the method of dynamic modeling of the workflow, with the use of information system.

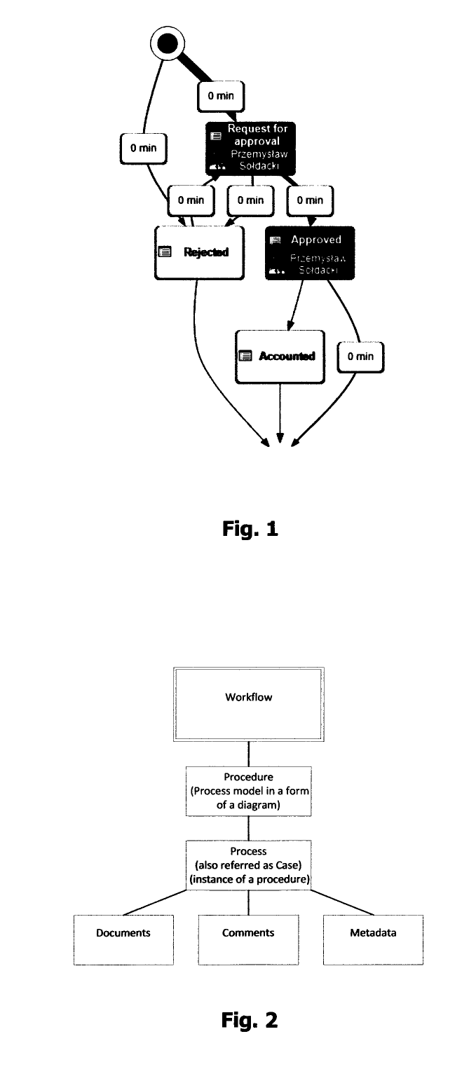

The electronic workflow is usually realized thorough the transfer of documents and information between the persons, where the documents and information are grouped into the processes (also referred to as the matters or issues; later in this document referred as cases). Every process is executed according to one of the procedures (sometimes referred to as the process models), whilst the procedure defines how this process is running, of which: what stages are taking place in the process and the transitions between the stages. The procedure often takes a form of diagram (flow graph), where one procedure can be used by many processes. An example of such solution is shown in the drawing, where FIG. 1 illustrates example of a diagram, while FIG. 2 illustrates a scheme of the hierarchy of notions.

Known method of workflow modeling using information system, involves designing of procedures by analyst, and then making an implementation into the system by a person with adequate skills. This method assumes also, that when making an analysis, all admissible stages, as well as transitions between the stages in procedure shall be predicted. The task of information system within this method is to supervise workflow process to run in conformity with designed procedures. In addition, in this method of modeling it is assumed, that within the procedure for each stage of workflow, the persons, or groups of persons, to which the documents have to be delivered shall be defined. Since the groups of persons are defined on the basis of organizational structure, this method of modeling assumes that also the organizational structure shall be entered into the information system. On the market, there are numerous systems, which use this method, e.g. products of Microsoft Company, basing on Windows Workflow Foundation, systems of Nintex Company, Open Text or IBM.

The disadvantage of this method is a high cost of performing the analysis, the effect of which is the procedures. Additional disadvantage lies in the cost of procedures implementation, as well as in entering of organizational structure to the information system. In the big organizations that are having many procedures, defining of detailed procedures and predicting all possibilities, often turns out to be practically unfeasible and the implementation is limited to the selected processes only. Moreover, such method of workflow modeling requires prediction of exceptional situations during analysis. Omission of exceptional situations in the analysis, later on results in the impossibility of mapping such situations in the information system, or else necessity of repeated analysis and entering of changes into the procedures within information system. The next disadvantage lies in the difficulty in entering of organizational changes, since every change of the process, or organizational structure is forcing to carry out the repeated analysis and introduction of changes into the procedures within information system. Additional workload is connected with defining of organizational structure, assigning of users to the elements of the structure, as well as defining of official dependencies.

### DETAILED DESCRIPTION

The method, being the subject of invention is characterized in that, the analysis of workflow processes, the effect of which is procedures, is performed automatically by information system, in such a way, that on the basis of information obtained from the system users during daily work, all actions taken by the users are registered, including the history of changes in each case, and then registered in this way flow of information between the persons and stages in every procedure is subjected to the automatic analysis, as a result of which the procedure diagrams are created with definable level of detail, that in the case of users behavior change are instantly updated, and in addition for prediction of user's behavior made on the basis of their decisions during the handing over the case, and the changes of the case stage, as well as all available information is followed by automatic creation of the classifiers and vector representations of the text content, which are then user to suggest the decisions concerning the next stage of procedure, as well as the next user, which should receive the case, on the basis of information about current user, present stage, previous stages, previous user, text contents as well as the metadata (additional attributes of given case) and also on the basis of the text content of new case, recognized and suggested is a procedure, according to which the given case should be carried on.

Within the confines of the method according to invention, the classifiers are created in a form of decision trees, decision tables, neural networks, genetic algorithms, rough sets, fuzzy sets, or other known methods of classification, based on the information concerning the current user, present stage, previous stages, previous user as well as the metadata (additional attributes of given case), at the same time for each pair of the case-stage created are two general classifiers containing information about typical decisions taken by all users during given stage of the procedure (one classifier for defining the next user, and one for defining the next stage), and in addition, created are detailed classifiers for every combination of the stage-case-user, which appeared during the use of system, at the same time decisions are suggested to the users by the application of suitable classifier and information from given case.

Within the confines of the method according to invention, the vector representations are first created as the vector representations of the text content of cases, and then created are vector representations of the procedures, as well as vector representations of the decisions, where the vector representations of decisions are created as detailed ones (for each combination of procedure stage and the user) and also as general ones (for the procedure stages with the information about users omitted).

Within the confines of the method according to invention, the diagrams of procedures are visualized in the Visualization Module (ViM) by the aggregation of historical data concerning the course of cases according to given procedure, where the nodes in so created diagram are corresponding to the stages, persons, pairs of stage-person, or departments from organizational structure, and the edges between nodes are created when the transition between given nodes takes place in historical data, whilst the number of transitions between nodes as occurring in historical data is represented by the edge thickness in a graph.

Within the confines of the method according to invention, suggesting the decisions is effected on the basis of classifiers as well as on the basis of vector representations, at the same time suggesting decisions on the basis of classifiers is effected in the Classifier based Decision Suggestion Module (CDSM), while suggesting decisions on the basis of vector representations is effected in the Vector Representations based Decision Suggestion Module (VRDSM).

Within the confines of the method according to invention, decision suggesting on the basis of classification files is effected in such a way, that the Classifier based Decision Suggestion Module (CDSM) is finding the appropriate classifier (corresponding to given procedure, stage and user), and then subjects the data of case to the classification process.

Within the confines of the method according to invention, decision suggesting on the basis of vector representation is effected in such a way, that the Vector Representations based Decision Suggestion Module (VRDSM) is creating the representation of current case, thereupon on the basis of data concerning current case finds the appropriate representations of decisions available at given stage of procedure for given user, and then using cosine measure, or other method of vector representation comparison, compared are vector representation of the case with the vector representations of decisions.

Within the confines of the method according to invention, recognition of the procedure is effected in such a way, that the Procedure Recognition Module (PRM) creates the representation of current case, and then using cosine measure compares the vector representation of case with the vector representations of procedures, and then the procedure, for which the value of cosine measure is highest, is being suggested to the user.

Within the confines of the method according to invention, selection of the suggestion with highest probability takes place in the Voting Module (VoM), where on the basis of voting suggestions from two modules are combined: i.e. that of Classifier based Decision Suggestion Module (CDSM) and the Vector Representations based Decision Suggestion Module (VRDSM).

The method according to invention features many advantages, among which one can mention:
the cost of analysis is significantly reduced, since the analysis is carried out automatically by information system, and not by human being,
the automatic analysis is based on information concerning the true course of processes, and not on the information obtained from users during the analytic interviews,
on the basis of carried out analysis, the system is suggesting to the users a decisions, which is facilitating their work, and at the same time enable them to take decisions regarding the course of processes, which makes possible the constant introduction of changes in the procedures and handling exceptions,
the automatic analysis is carried out in a continuous way, owing to which any changes in the course of processes are included in the analysis, and are noticeable to the decision makers.

Within the confines of the method according to invention, the users of information system enjoy full freedom of sending information and documents to each other, as well as defining of information flow. All pieces of information and documents are grouped into the cases. In particular, every user has a possibility to:
send a case to any person,
define the persons, that shall be notified about the case, and shall have access to it,
add his/her comments to the case and add attachments,
create a new procedure by entering its name, or select already existing procedure,
create the stage of procedure by entering its name, or select already existing stage,
define new elements of the organizational structure, e.g. departments in the organization, in a form of hierarchical structure,
provide an information concerning his/her position in the organizational structure, title of his/her position and indicate his/her superior,
define the descriptive forms (metadata) in the form of additional attributes describing the cases in given procedure. The type of attributes can be either textural, numerical, as a date, list of selection and other.

Moreover, selected person have additional possibility of monitoring and optimizing the processes of workflow. Such persons can be managers, heads of department, analysts etc. These persons have at their disposal the following possibilities:
overview of created procedures and stages,
modification of the names of procedures and stages,
removal of redundant stages, by joining them with other stages,
deletion of redundant procedures by joining them with other procedures. During such process of joining, all stages from removed procedure are transferred to the other procedure, and all cases already executed or being executed according to removed procedure are switched to the other procedure,
imposing of limitations onto selected transitions in procedures, e.g. sending information between indicated persons, or departments, as well as the passage between indicated stages of procedure. These limitations can be of the following character: warning to the -4-user, “soft” lock, which can be violated by the user, however it shall result in notification to the author of lock and the superior of given user, or “hard” lock, which cannot be violated by the user,
browsing and modification of the organizational structure through the correction of the department names, changing of the dependence between the departments, assigning users to the departments, and also official dependence superior-subordinate,
browsing and correction of the descriptive forms in a form of attributes of the procedures through modification of names, type and the sequence of attributes. There is also a possibility of deactivation of the selected attributes.

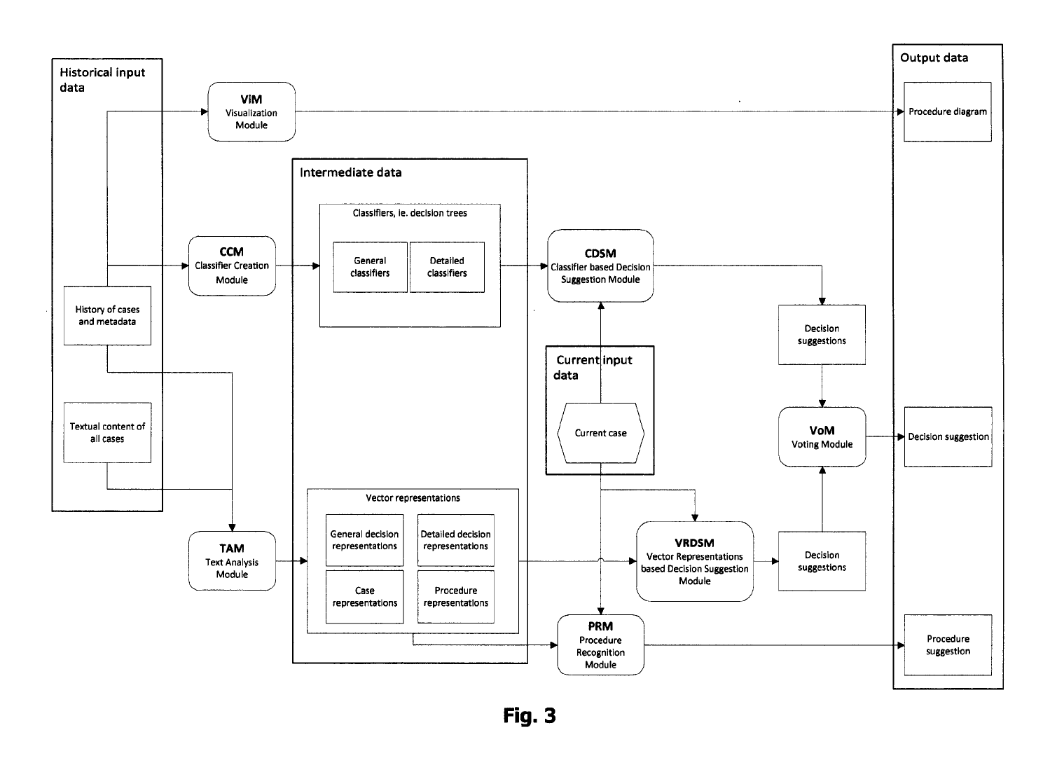

The method according to the invention was explained by the way of example in the drawing, in which FIG. 3 shows the diagram of carrying out the automatic analysis of the workflow process with the use of information system.

Within the confines of the method according to invention, information system contains the modules, which are designed for carrying out the automatic analysis, i.e.:
Visualization Module (ViM),
Classifier Creation Module (CCM),
Text Analysis Module (TAM),
Classifier based Decision Suggestion Module (CDSM),
Vector Representations based Decision Suggestion Module (VRDSM),
Procedure Recognition Module (PRM),
Voting Module (VoM),

Analysis of the workflow processes, the effect of which are the procedures, is carried out automatically by the information system on the basis of information as obtained from the system users, during their daily work, and is not performed by the analyst before starting of the system.

The information system is acquiring the data pertaining to the following questions:
what procedures are used by the users,
from which stages the procedures are made up,
what transitions occur between the stages,
to whom the users are sending the information,
what decisions are taking the users, depending on the content of given case (textual information and metadata) as well as the history of given case,
what is the organizational structure and official dependence between the users,
what metadata are employed by the users in each procedure.

On the basis of collected information concerning current user, current stage, previous stages, previous user as well as metadata (additional attributes of given case) the Visualization Module (ViM) is creating the diagrams of procedures. Visualization of procedures is effected through the aggregation of historical data on the course of cases according to given procedure, at the same time the nodes in the diagram being created, are corresponding to the stages, persons, pairs stage-person, or departments from organizational structure, and the edges between nodes are created if the transition between the given nodes is occurring in historical data. The number of transitions between the nodes, occurring in historical data is represented in a graph by the edge thickness. This facilitates also an omission of rarely occurring edges through defining the minimum threshold number of the occurrences of given transition in historical data.

On the basis of cases history and metadata, the Classifier Creation Module (CCM) creates automatically (during analysis) classifiers in a form of decision trees, where for each pair procedure-stage created are two general classifiers containing the information about typical decisions taken by all users at given stage of the procedure (one classifier for defining of next user, and one for defining the next stage), as well as additionally built are detailed classifier for every combination stage-procedure-user, which has occurred during the use of system.

In order to take into account the textual information, Text Analysis Module (TAM) creates the vector representations of cases, procedures and decisions. First of all, created are vector representations of the cases' text content, with the use of the method of text exploration, so called “bag-of-words”, i.e. building of multidimensional vectors, where each dimension corresponds to one word, and the value of given vector coordinate contains the measure TF-IDF of given word in given case. The TF-IDF measure is calculated on the basis of known formula:

m_{TF-IDF}=TF(w, c)·log(|D|/DF(w)), where
TF(w, c) denotes the number of word occurrences in the case c,
DF(w) denotes the number of cases, in which word iv has appeared,
   |D| is a number of all cases under consideration.

Then, created are vector representations of the procedures (in order to procedure recognition during further steps of the method), as well as the vector representations of the decisions (in order to suggest the decision during further steps of the method), at the same time, the vector representation of a procedure is a vector created by adding up the vectors of cases of all cases carried out according to the given procedure, however the vector representation of a decision, is a vector created by adding up the vectors of all cases, in which at given stage the user took a given decision. Similarly, like in the case of decision trees, created are detailed vector representation of the decisions (build for each combination of the procedure stage and user) as well as the general ones (build for the procedure stages with omission of the information about users).

In order to suggest the decisions on the basis of classifiers, Classifier based Decision Suggestion Module (CDSM) on the basis of current case data finds the appropriate classifier (corresponding to given procedure, stage and the user), and then subjects the data of current case to the process of classification, the result of which is the suggestion of decision.

In order to suggest the decisions on the basis of vector representations. Vector Representations based Decision Suggestion Module (VRDSM) creates a representation of current case, and thereafter, on the basis of the data concerning the current case, finds the appropriate representations of the decisions available at a given stage of procedure for given user, and then by means of cosine measure, or other method of vector representation comparison, compares the vector representation of the case with the vector representations of a decision, as a result of which decision is suggested. In the case, when given user has never took a decision at given stage, and for him there are no detailed representations of decision, then the general representations of decision for given stage are used. The decisions with the highest value of cosine measure are suggested to the user.

In order to recognize the procedure, the Procedure Recognition Module (PRM) creates the representation of current case, and then with the use of cosine measure compares the vector representation of the case with the vector representations of procedures. The procedure, for which the value of cosine measure is highest, is suggested to the user. The cosine measure for vectors d1 and d2, as calculated according to formula (where the scalar product of vectors is marked with asterisk):

cos(d1 , d2)=(d1*·d2)/∥d1∥∥d2∥

In order to select the suggestion with highest probability, the Voting Module (VoM), on the principle of voting i.e. by adding up the probabilities of input suggestions, joins suggestion from two modules: i.e. Classifier based Decision Suggestion Module (CDSM), and Vector Representations based Decision Suggestion Module (VRDSM).

1. The method of dynamic modeling of workflow, with the use of information system is characterized in that, the analysis of workflow processes, the effect of which is procedures, is performed automatically by information system, in such a way, that on the basis of information, as obtained from the systems users during daily work, all actions taken by the users are registered, including the history of changes in each case, and then registered in this way flow of information between the persons and stages in every procedure is subjected to the automatic analysis, as a result of which the procedure diagrams are created with definable level of detail, that in the case of users behavior change are updated instantly, and in addition for prediction of user's behavior on the basis of taken by them decisions during the handing over cases, and the changes of the case stages, as well as all available information, classifiers and vector representations of the text content are automatically created, which are then used to suggest decisions concerning the next stage of procedure, as well as the next user, which should receive the case on the basis of information about current user, present stage, previous stages, previous user, text contents as well as the metadata (additional attributes of given case) and also on the basis of the text content of new case, recognized and suggested is a procedure, according to which the given case should be carried on.

2. The method according to claim 1, wherein the classification files are created in a form of decision trees, decision tables, neural networks, genetic algorithms, rough sets, fuzzy sets, or other known methods of classification, based on the information concerning the current user, present stage, previous stages, previous user as well as the metadata (additional attributes of given case), at the same time for each pair of the procedure-stage created are two general classification files containing information about typical decisions taken by all users during given stage of the procedure (one classification file for defining the next user, and one for defining the next stage), and in addition, created are detailed classification files for every combination of the stage-procedure-user, which appeared during the use of system, at the same time decisions are suggested to the users by the application of suitable classifier and information from given case.

3. The method according to claim 1, wherein the vector representations are first created as the vector representations of the text content of cases, and then created are vector representations of the procedures, as well as vector representations of the decisions, where the vector representations of decisions are created as detailed ones (for each combination of procedure stage and the user) and also as general ones (for the procedure stages with the information about users omitted).

4. The method according to claim 1, wherein the diagrams of procedures are visualized in the Visualization Module (ViM) by the aggregation of historical data concerning the course of cases according to given procedure, where the nodes in so created diagram are corresponding to the stages, persons, pairs of stage-person, or departments from organizational structure, and the edges between nodes are created when the transition between given nodes takes place in historical data, whilst the number of transitions between nodes as occurring in historical data is represented by the edge thickness in a graph.

5. The method according to claim 1, wherein suggesting the decision is effected on the basis of classifiers as well as on the basis of vector representations, where suggesting of decisions on the basis of classifiers is effected in Classifier based Decision Suggestion Module (CDSM), while suggesting decisions on the basis of vector representations is effected in Vector Representations based Decision Suggestion Module (VRDSM).

6. The method according to claim 5, wherein decision suggesting on the basis of classifiers is effected in such a way, that Classifier based Decision Suggestion Module (CDSM) is finding the appropriate classifier (corresponding to given procedure, stage and user), and then subjects the data of current case to the classification process.

7. The method according to claim 5, wherein decision suggesting on the basis of vector representation is effected in such a way, that Vector Representations based Decision Suggestion Module (VRDSM) is creating the representation of current case, thereupon on the basis of data concerning current case finds the appropriate representations of decisions available at given stage of procedure for given user, and then by means of cosine measure, or other method of vector representation comparison, compared are vector representation of the case with the vector representations of decisions.

8. The method according to claim 1, wherein recognition of the procedure is effected in such a way, that Procedure Recognition Module (PRM) creates the representation of current case, and then with the use of cosine measure compares the vector representation of the case with the vector representations of procedures, and then procedure, for which the value of cosine measure is highest, is being suggested to the user.

9. The method according to claim 1, wherein selection of the suggestion with highest probability takes place in Voting Module (VoM), where on the basis of voting suggestions from two modules are combined: i.e. that of Classifier based Decision Suggestion Module (CDSM) and Vector Representations based Decision Suggestion Module (VRDSM).
